(19) United States
(12) Patent Application Publication
(10) Pub. No.: US 2008/0250333 A1
(43) Pub. Date: Oct. 9, 2008

(54) COLLABORATIVE WORKSPACE

(75) Inventors: Bernard Reeves, Midland, MI (US); Michael Bradley Gee, Midland, MI (US)

Correspondence Address: JAMES D. STEVENS;REISING, ETHINGTON, BARNES, KISSELLE, P.C., P.O. BOX 4390, TROY, MI, 48099, US

(73) Assignee: DOW CORNING CORPORATION, Midland, MI (US)

(21) Appl. No.: 12/062,891

(22) Filed: Apr. 4, 2008

Related U.S. Application Data
(60) Provisional application No. 60/910,467, filed on Apr. 6, 2007.

(51) Int. Cl. G06F 3/00

(52) U.S. Cl. 715/753

(57) ABSTRACT

A computer-based system and method for organizing and sharing information in a workspace. The system includes a workspace engine that implements the workspace using projects and associated notecards. A web server provides the projects and notecards to one or more client computers for display. Each notecard contains information related to such things as materials, solutions, advice, contacts and the like, and for this purpose includes restricted, public, and information sections containing different portions of the information. Each project has one or more notecards or other projects associated with it and are used by the system to enable users to collaborate on the project.

### CROSS-REFERENCE TO RELATED APPLICATION

This application claims the priority of U.S. Provisional Application No. 60/910,467, filed Apr. 6, 2007, the entire contents of which are hereby incorporated by reference.

### TECHNICAL FIELD

The present invention generally relates to the organization and presentation of information and, more particularly, to systems and methods of sharing, organizing, and presenting information.

### BACKGROUND OF THE INVENTION

The collaboration of ideas, thoughts, designs, contacts, and the like has historically involved a group of individuals working within a common geographical location. The Internet has made it easier for individuals to work together when some or all of the individuals are located in remote geographical locations from one another. This is because the Internet has enabled connectivity between people and groups of people, such as through virtual private networks, databases, email, message boards, Internet chat rooms, and web-based presentation systems.

Existing Internet tools often do a poor job of enabling an individual or a group to both organize and share thoughts and information with others. Some Internet tools such as email and chat rooms allow members to share information with others, but they generally do a poor job of organizing the information for later reference. Moreover, the information is generally not available to the public when using these tools. Other tools, such as message boards, can enable the public and/or a predetermined group of individuals to view the information. But again, the tools do not allow for much collaboration and generally do not organize the information.

### SUMMARY OF THE INVENTION

In accordance with one aspect of the invention, there is provided a method for organizing and sharing information. As a part of the method, at least one notecard is generated upon request. The notecard contains a restricted section and a public section, the restricted section accepting information from a creator of the notecard and restricting information sources other than the notecard creator, and the public section accepting information from at least one source other than the notecard creator. The method also includes the steps of accepting information into the notecard, generating at least one project, and associating one or more notecards with one or more projects. The notecard and/or project can be maintained at a server and then displayed on a client computer having access to the server.

In accordance with another aspect of the invention, there is provided a system for organizing and sharing information in a workspace. The system includes a web server, workspace engine operationally linked with the web server, and a client connected to the web server through a communication link. The workspace engine maintains the workspace and handles management of at least one notecard and at least one project for the workspace. The notecard includes a restricted section for accepting information from a creator of the notecard and restricting information from sources other than the notecard creator. The notecard also includes a public section for accepting information from at least one source not accepted by the restricted section. One or more of the notecards are associated with the project. Both the notecards and projects can be accessed from the web server and displayed at the client.

### BRIEF DESCRIPTION OF THE DRAWINGS

Preferred exemplary embodiments of the present invention will hereinafter be described in conjunction with the appended drawings, wherein like designations denote like elements, and wherein:

FIG. 1 is a block diagram of a system for organizing and sharing information between a number of individuals in various geographic locations;

FIG. 2 is a schematic diagram of a window for creating and/or editing notecards;

FIG. 3 is a schematic diagram of a window for creating and/or editing projects; and

FIGS. 4-6 are flowcharts showing some of the steps of an embodiment of a method of organizing and sharing information through the use of projects (FIG. 4), notecards (FIG. 5), and the collaborative workspace (FIG. 6) that are provided by the system of FIGS. 1-3.

### DETAILED DESCRIPTION OF THE PREFERRED EMBODIMENTS

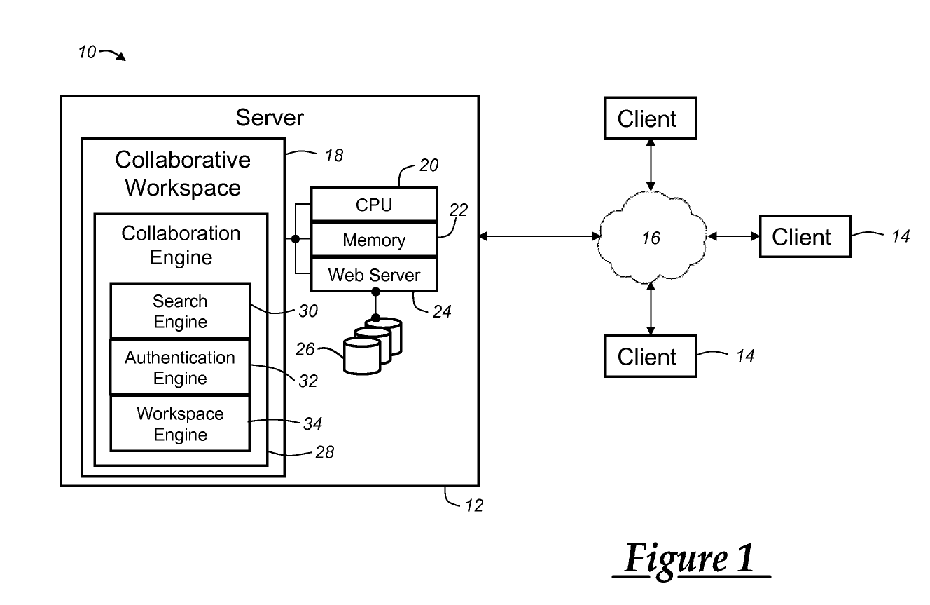

FIG. 1 shows an exemplary collaborative workplace system 10 constructed in accordance with the invention as it might be used for sharing, organizing, and providing feedback on ideas, projects, and the like. The system 10 includes a server 12, and one or more clients 14 connected over the Internet 16. The server 12 provides a collaborative workspace 18 accessible via client 14 for storing, sharing, organizing, and providing feedback on ideas and projects. The collaborative workspace 18 is a web enabled application environment having an interactive user interface enabling users to collaborate with one another. Collaboration in the workspace 18 occurs when users create projects and notecards to share with other users, combine projects and notecards, and provide comments and feedback on goals, ideas, and designs expressed in the projects and notecards.

The server 12 and client 14 can include common computing hardware such as a central processing unit (CPU) 20 and memory 22. The CPU 20 can be a conventional microprocessor. The memory 22 can include random access memory (RAM) and/or read-only memory (ROM). In one embodiment, clients 14 can be any type of computing device that supports a web browser and is able to communicate with servers via the Internet 16. For example, the clients 14 can be a personal computer, a handheld device such as a web-enabled personal data assistant, and the like.

The server 12 can also include a web server 24, one or more optional databases 26, and a collaboration engine 28. The web server 24 enables clients 14 to connect to the workspace 18 over the Internet. Web server 24 can enable multiple clients 14 to connect to the workspace 18 at the same time and can allow the clients to be located anywhere in relation to the server 12.

The databases 26 can store and retrieve data for the workspace 18. The databases 26 can be incorporated into the computing hardware and software. Alternatively, the databases 26 can be distributed from the computing hardware and linked to the server via a network such as a local area network.

The collaboration engine 28 includes logic for enabling the collaboration workspace 18. The collaboration engine 28 includes search engine 30, an authentication engine 32, and a workspace engine 34. The search engine 30 allows members to search the workspace 18 to obtain search results. Search engines are known in the art and as such, the search engine 30 can comprise typical search engine technology. The search engine 30 performs keyword searching for text and tags in the workspace 18 and returns results based on the search.

The authentication engine 32 provides login and password authentication as well as management for member accounts. The members can register for an account through the authentication engine 32 to obtain access to various features of the workspace 18. The authentication engine 32 can restrict some or all collaboration engine 28 functionality to registered members.

The workspace engine 34 handles content creation and manages content for the workspace 18. Specifically the workspace engine 34 creates content upon request from registered members. In addition to core content (notecards and projects), the workspace engine handles user generated ratings, reviews, and tags. The workspace engine 34 also handles metadata associated with the content, calculates statistics based upon the metadata, and provides authorization for viewing and editing content. For example, creators of content can select whether it is viewable by the public, viewable by a limited selection of authorized members, or is viewable only by the creator. The workspace engine 34 handles which members can view the content based upon settings for the content and upon members selected by the content creator.

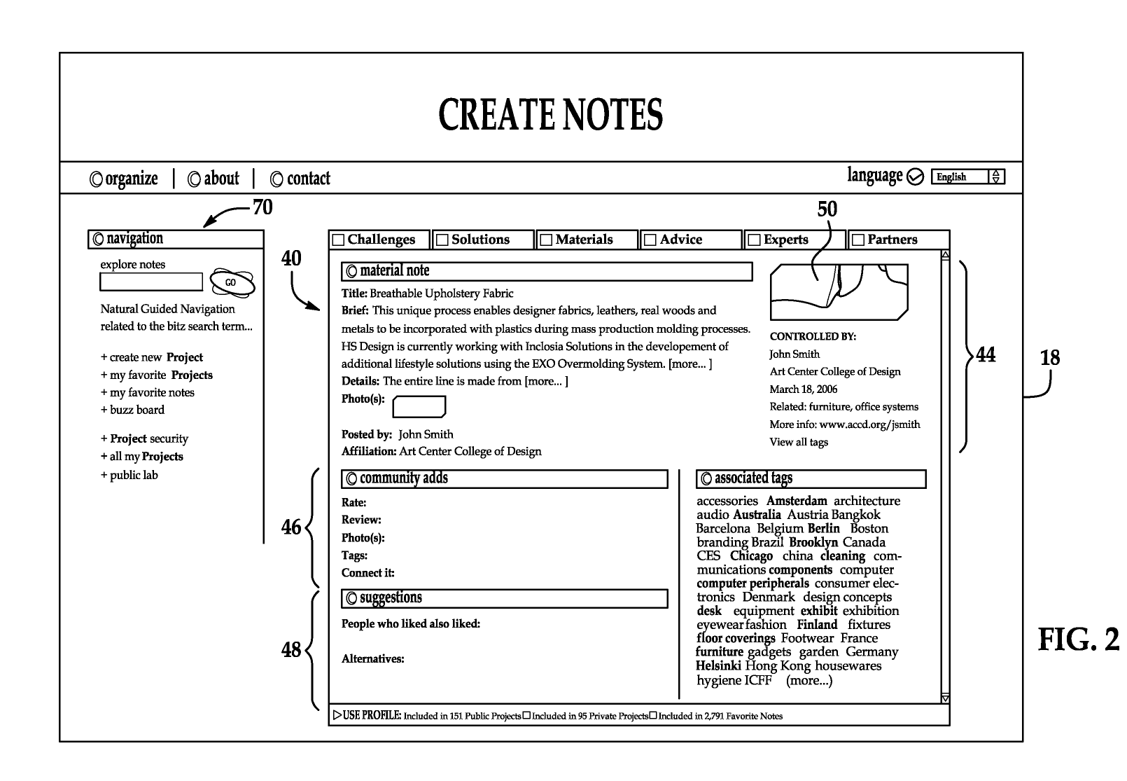

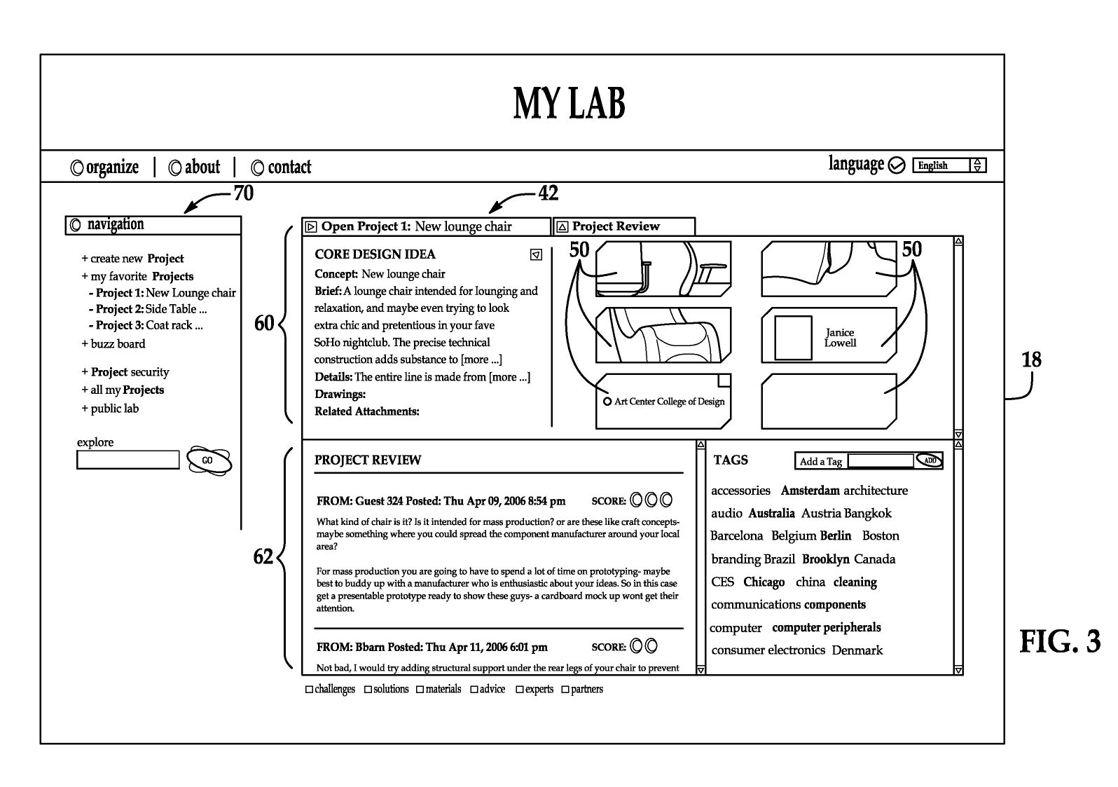

A representative screen display of a portion of the workspace 18 is shown in FIGS. 2 and 3. Workspace content includes notecards 40 and projects 42. Members can generate notecards 40 containing ideas related to materials, solutions, advice, contacts, and the like. Members can also organize the notecards 40 into various projects, and provide feedback on the projects 42 and the notecards 40. The feedback can include such things as reviews, ratings, and tags. The workspace is a shared space accessible through the Internet so that many people can contribute ideas by creating the notecards 40, associating those notecards 40 with projects 42, associating projects 42 with other projects 42, and providing feedback. Security settings allow members to save and organize their notecards 40, enable members to keep some notecards 40 and projects 42 private, and share other notecards 40 and projects 42 with others.

Notecards 40 are a fundamental record of information created by a member or members. Notecards 40 can contain information to communicate and organize ideas, thoughts, problems, solutions, advice, concepts, contacts, and the like. Notecards 40 provide a record of these thoughts, ideas, solutions, etc. for later reference by their creator or for sharing with other members. FIG. 2 shows one embodiment of a graphical user display for viewing and/or editing notecards 40. Notecards 40 can contain multiple sections including a restricted section 44, and a public or community section 46. Notecards 40 can also include an information section 48.

The restricted section 44 includes information provided by the notecard's creator. The restricted section 44 is not editable by other members. Examples of information included in the restricted section 44 can include a title for the notecard 40, a description of the notecard 40, a summary, images, and information about the creator. The description contains the core information for the notecard 40 including the thoughts and ideas recorded by the note's creator. For example, a notecard 40 documenting a potential problem for a given project 42 can include a written description of the problem in the description of the notecard. The summary can include a brief synopsis of the description.

The image section can contain thumbnails and/or links to images associated with the notecard 40. The link allows member to view the image in a web browser. The creator can upload the images to the server by selecting to associate an image with the notecard 40 in the image section. The notecard's creator can select one of the images for use as an icon 50 for its notecards. The icon 50 is displayed in the workspace as a graphical representation of the notecard 40 in the workspace as shown in FIG. 3.

The creator information can include the name of the creator, the company or employer of the creator, the date the notecard 40 was first created, the date of the most recent update of the notecard 40, a web link provided by the creator, and the like. This information can be retrieved from a specialized notecard 40 called a member card (discussed below).

The restricted section 44 can also include a category selected for the notecard.

Categories can be predefined by the workspace engine 34, the creator, or the workspace community. Examples of categories can include materials, problems, challenges, solutions, experts, partners, advice, and the like. Selecting a category for the notecard 40 can enable the creator and project 42 members to organize their notecards 40 into classifications or categories. Moreover, the categories can enable the search engine 30 to provide results targeted to a member's search request.

The public section 46 of the notecard 40 is editable by registered members and can include items such as ratings, reviews, comments, images, tags, links to information related to the notecard 40, and the like. The ratings can include one or more ratings from registered members and an overall rating for the notecard 40 compiled from all member ratings. Registered members can provide one rating for notecards 40, such as, for example, by selecting a number of items such as stars, dollar signs, and the like, or by entering a number corresponding to the rating of the notecard. Once the member has rated the notecard 40, the member cannot provide a second rating for the notecard. In one embodiment, the overall rating for the notecard 40 can be calculated by taking the average of all member ratings for the notecard. The overall rating enables members to quickly gauge the opinion of the community regarding the usefulness of the notecard 40.

The reviews/comments enable members to share their opinions and experiences with others, including the notecard creator. Members can provide a written opinion of the notecard 40 and provide feedback within the notecard 40 to the notecard creator and other members. For example, a notecard 40 describing a type of material that can be used for a chair can receive a review and/or comments from authenticated members. The comments allow anyone who views the notecard 40 to read the review/comments and thus benefit from information contained in the review.

Authenticated members can upload and/or link images with the notecard 40 in the communication section. The images and links can appear similar to those in the restricted section 44.

Authenticated members can also associate tags with the notecard 40. Tags are keywords or terms associated with notecards. Tags enable keyword-searching and classification of notecards 40 based upon the notecard's content. For example, a notecard 40 containing information for a stain resistant material for a chair can have tags like fabric, chair, furniture, stain resistant, and the like. Members can select to view notecards 40 related to the tag “furniture” and see all notecards 40 having the tag “furniture” associated with them.

The information section 48 lists information related to the notecard 40 obtained by the workspace engine 34 such as statistical information and suggestions as shown in FIG. 2. The workspace engine 34 can generate statistical information by analyzing metadata associated with the notecard 40. The metadata can include the number of projects 42 associated with notecard 40, the number of members who have selected the notecard 40 as a “favorite,” and the like. The statistics can allow members to gauge the popularity of notecards 40 by others. In one embodiment, the overall rating of the note is listed in the information section 48.

The suggestions can reference notecards 40 with information related to the notecard open in the workspace 18. For example, if the open notecard 40 refers to a fabric material for a chair, the suggestions can include links to other notecards 40 related to fabrics for chairs. The suggestions can be provided by the workspace engine 34. The workspace engine 34 can list alternatives based on the tags associated with the notecard 40. For example, the workspace engine 34 can analyze the tags associated with notecard 40 and list other notecards associated with similar tags. The workspace engine 34 can also take the rating and statistics of those notecards 40 into account when selecting which notecards to suggest. The suggestions can also list members in the community who provided a high rating to the notecard 40 and list other notecards 40 that those members rated highly.

Notecards 40 can also be specialized. Examples of specialized notecards 40 can include member notecards and category notecards. The workspace engine 34 generates a member notecard 40 for each new registered member. The member notecard is similar to other notecards 40 except that the restricted section 44 is limited to creator information and an icon 50. Like with other notecards 40, member notecards contain a public portion. The public portion allows other members to rate the member and provide reviews for the member. The member's rating is a way for the community to gauge the reputation of the member. The information section 48 of the member notecard can also contain statistical information such as the number of reviews, notecards 40, and projects 42 the member has created.

Member notecards can also be used to rank members. The collaboration engine 28 can use the ratings of a member along with other statistics, such as the number of notes they created, the number of projects 42 they created, the number of reviews they have provided, and the like to rank members. Members who reach a predefined ranking can be categorized as experts. Experts can be given added privileges such as having their reviews listed first on notecards 40 and projects 42, providing additional weighting to their ratings of other members, notecards 40, and projects 42, being noted as an expert on their member notecards, in reviews, and the like.

Members can create category notecards to organize other notecards. The creator of the category notecard defines a category for the notecard. For example, the creator may create a category notecard for organizing notecards 40 related to marketing services. All notecards 40 dealing with marketing services can be associated with the category notecard. Once created, the category notecard is not owned by its creator. Category notecards are public property and any authenticated user can associate notecards 40 with the category notecard. The content within the category notecard can be restricted to a category, a description of the category, an icon 50, a list of notecards 40 associated with the category notecard, and a list of projects 42 with which the category notecard is associated.

FIG. 3 shows one embodiment of a project 42 window which, like that shown in FIG. 2 is a graphical user display of the project that can be displayed on any of the client computers 14. Projects 42 define a goal or group of goals and can incorporate relevant notecards 40 and/or other projects 42 to attain the defined goals. Projects 42 can also enable multiple members to collaborate, share information, and/or promote designs or solutions created by an individual or a group. The projects 42 include a controlled section 60 and a shared section 62.

The controlled section 60 can include an overview of the project 42, a list of notecards 40, and a list of other projects 42 associated with the project 42. Information contained in the overview can include a title, a written description, images, and attachments. The written description can include a brief description of the concept of the project 42 and can include the project's goals, purpose, challenge, or other brief description to describe why the project 42 was created. The written description can also include specific details such as who is/was working on the project and other like information. The project 42 can also include a written summary of the overall project 42.

Images can be uploaded and/or linked to the project 42 in a manner similar to notecards 40. The project creator can select one of the images as an icon 50 for the project 42 to provide a graphical representation of the project 42 in the workspace. The icons 50 shown in FIG. 3 depict various notecards and other projects associated with the displayed project 42. Likewise, attachments can be linked to the project 42 to allow members to view text documents, presentations, and other types of files useful for understanding the project 42.

The overview may also contain specialized categories for projects 42. Some specialized categories can include challenges and solutions. Challenges request members to provide suggestions to solve a problem. For example, a member may create a challenge project 42 to request members to provide designs to satisfy a set of requirements defined by the project creator. In contrast, solutions are completed projects 42 and may be used to demonstrate work done by a member or team of members or provided as a solution to a challenge.

The shared section 62 can include reviews and tags for the project 42. Members can provide reviews for projects 42 similar to reviews for notecards 40. The reviews are visible by other members and the project creator. Reviews can contain written comments on the project 42 as shown in FIG. 3. The review can also include a rating for the project 42 similar to ratings assigned for notecards 40. The rating can help members find and locate projects 42 approved by the member community. The rating from each member can be displayed near the written comments from that member. An overall rating for the project 42 can be computed by the workspace engine 34 and displayed on the project 42. In one embodiment, the overall rating can be calculated by taking an average of the member ratings for the project 42.

Similar to notecards 40, projects 42 can also include tags. The tags can be associated with the project 42 by the project creator or by other members in the community. Alternatively, tags can be generated and assigned to projects 42 by the workspace engine 34. The tags can be used for locating projects 42 related to subject matter of interest to a member. The tags may also appear on the project 42 as a hyperlink. Clicking on a tag may open a list of projects 42 associated with that tag and allow the member to browse the list of projects 42.

Both notecards 40 and projects 42 can be assigned a security level. In one embodiment, notecards 40 and projects 42 can be divided into one of three categories: public, shared, or private. Public notecards 40 and projects 42 can be viewed by any member of the member community. Members can be required to provide an authenticated login and password verified by the authentication engine 32 in order to view the notecards 40 and/or projects 42. In one embodiment, members are not required to have an authenticated login and password to view the notecards 40 and projects 42, but can be required to have an authenticated login and password to review or edit information in the shared section 62 of notecards 40 and/or projects 42.

Shared notecards 40 and projects 42 are not visible by all registered members. Rather shared notecards 40 and projects 42 can be viewed only by members authorized by the note/project creator to view the note/project 42. In one embodiment, the note/project creator can authorize a member to view the project 42 but not edit and/or review the project 42. In this embodiment, the note/project creator must authorize the member to not only view the project 42 but to also edit and/or review the note/project 42 in order for the member to be enabled to do so.

Private notecards 40 and projects 42 are not visible by any members of the member community other than their creator. The creators can therefore maintain control of the notecards 40 and/or projects 42 as well as keep them secret. Private notecards 40 and/or projects 42 are useful for creators to maintain a record of their ideas and/or projects 42 while maintaining secrecy of the idea and/or project. In one embodiment, creators are able to change the security level of their notecards 40 and/or projects 42 at any time.

The workspace engine 34 can also provide statistical information to members based on metadata associated with projects 42 and/or notecards 40. For example, the workspace engine 34 can provide lists of the most popular notecards 40 and/or projects 42. The lists can display the popular notecards 40 by category. For example, the lists can display the most popular notecards 40 related to materials, problems, solutions, experts, advice, and the like. The list of the most popular notecards 40 and projects 42 can be based upon the number of times each notecard 40 or project 42 has been viewed by members. Alternatively, the list can be generated based upon the ratings of notecards 40 and/or projects 42 by members. In one embodiment, registered members can select notecards 40 and/or projects 42 as a favorite. As such, the list can be based upon notecards 40 and/or projects 42 selected as a favorite by the most number of members. The list can provide titles of the notecards 40 and/or projects 42 selected for the list. Clicking on the titles can link the member and open a window containing the notecard 40 and/or project 42 selected in the list. The lists can also be served to other websites. Websites may link to the lists through an RSS feed to provide their visitors with links to the most popular notecards 40 and projects 42 on particular subjects.

The collaboration engine 28 can also provide links and news of interest to the community from other sites. The collaboration engine 28 can provide an RSS feed to websites containing relevant information to the community. The information can include news articles, advertisements from sponsors, and the like.

The collaboration workspace can also include a navigation section 70 as shown in FIG. 3. The navigation section 70 can include a list of links for the workspace 18. The links can be provided for opening a new project 42, navigating to a member's favorite projects and notecards, editing notecard security settings, project security settings, listing a member's projects, and the like. By clicking on the links, a member can command the workspace engine 34 to perform an action or navigate to a particular location. Alternatively, clicking on a navigation link can open a list of other options. For example, clicking on “my favorite projects” can expand a list of the member's favorite projects 42. Clicking on any of the projects 42 listed navigates the member to that project 42 window.

The navigation section 70 can also include a search tool. The search tool can include a text box for entering keywords or tags to conduct a search of notecards 40 and/or projects 42. The search tool can also include a list of categories for narrowing the scope of the search. The search is processed using the search engine 30 described above.

The workspace 18 also provides a working section that lists notes and projects 42 for each member. Each member has its own working section and only that member can view their working section. The working section can include several tabs for organizing notecards 40 and projects 42. All notecards 40 and projects 42 created by a member are automatically listed. The member can also add notecards 40 and projects 42 created by other users by selecting to add them to their working section. The member can also select particular notecards 40 and projects 42 as a “favorite” to differentiate them from their other notecards 40 and projects 42.

### Method for Creating a Project

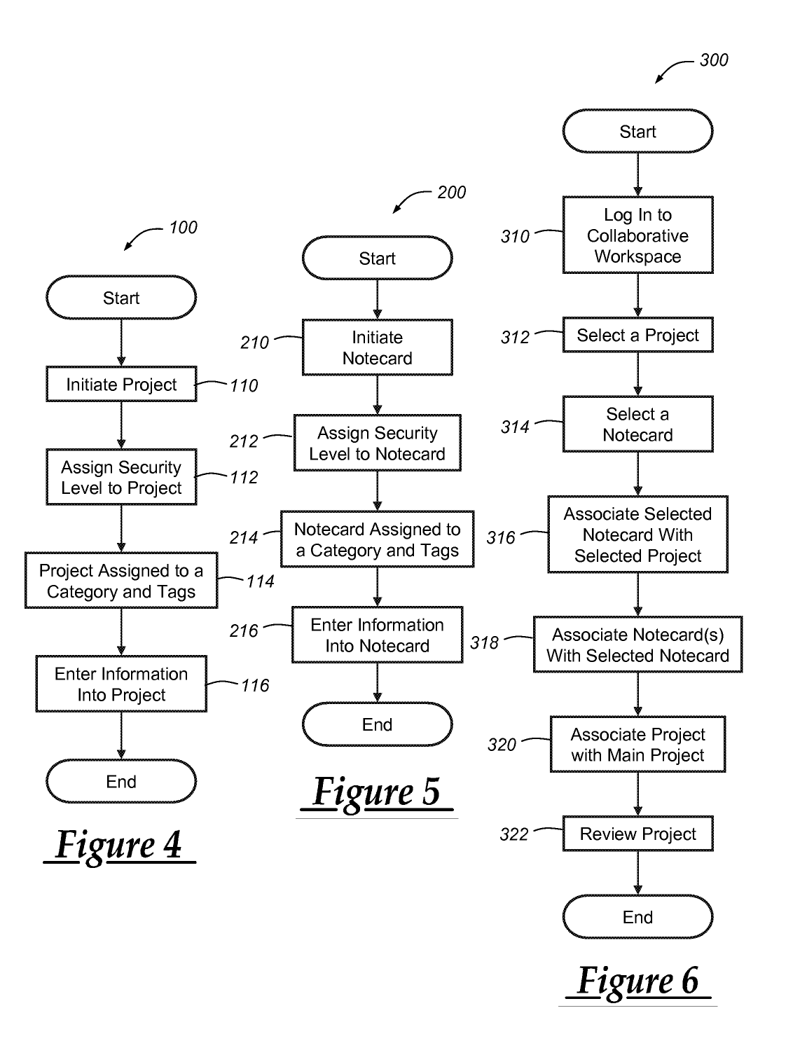

Turning now to FIG. 4, there is shown an embodiment 100 of a method for creating a project 42. According to this particular embodiment, method 100 begins with a user initiating at least one main project 42 at step 110. The user, or project creator, can create the project 42 by selecting “Create New Project” from the navigation menu, which instructs the workspace engine 34 to launch a window containing a new project. In one embodiment, any registered member can initiate the project 42. The project creator may also initiate an object in software that encapsulates the data and methods associated with the project 42. For example, the object may include a notecard 40, images, and the like for association with the project 42.

At step 112, the project 42 is assigned a security level. For example, the project creator can select the project 42 to have a security level such as public, shared, private, and the like. Selecting a public security level enables any member to view the project 42 and the information provided with the project 42. The public level also enables registered members to provide a rating for the project, enter a review for the project, and associate tags with the project 42.

The project creator can alternatively select the security level of the project 42 to be shared. A shared project 42 enables the project creator to authorize members to view and/or edit the project 42. In one embodiment, authorized members are able to both edit and review the project 42. In another embodiment, the project creator can select whether the authorized member is able to review or edit the project 42. For example, the creator can enable only certain authorized members to both review and edit the project 42. Editing the project 42 can include modifying existing information in the project 42 as well as adding additional images and linking the project 42 with related attachments. Other authorized members are limited to viewing, reviewing, and rating the project 42. In yet another embodiment, the project creator can authorize members to view the shared project 42 and can prevent them from providing a review or editing the project 42.

The project creator can also select the project 42 to be private. The private project 42 restricts any member other than the project creator from viewing, reviewing, and/or editing the project 42.

At step 114, the project 42 is assigned to a category. Project 42 categories may include challenges, solutions, and the like. In one embodiment, the project 42 categories can be predefined by the workspace engine 34 and may determine characteristics of the project 42. For example, a solution project may prevent any member other than the project creator from adding notecards 40 or other projects 42 to the solution. In contrast, a challenge project may allow authorized members to add notecards 40 and/or projects 42 to the challenge project.

At step 116, information can be entered into the project 42. The project creator can provide basic information to inform others of the projects' purpose and goals. The creator can provide information such as a project 42 title, a description of the project, a concept for the project, and the like. Other information can include a summary of the project, images to help others understand that project, and related attachments including written documents, presentations, and the like.

### Method for Creating a Notecard

FIG. 5 shows a method 200 for creating a notecard 40. At step 210, at least one notecard 40 is initiated. In one embodiment, the notecard 40 is initiated by a registered member. The member who initiates the notecard 40 is called the notecard creator. The notecard creator can initiate the notecard 40 by selecting “Create New Note” from the navigation menu, which instructs the workspace engine 34 to launch a window containing a new notecard. The creator can enter information into the restricted section 44 of the notecard 40 such as the note's title, a detailed description, a summary, images, and the like. The creator can also assign initial tags.

At step 212, a security level is assigned to the notecard 40. The security levels can include public, shared, private, and the like. The public notecards allow any member to view the notecard 40. Authorized members can provide information in the public section 46 of the notecard 40 and associate the notecard 40 with a project 42. The shared level enables members authorized by the notes' creator to view the notecard 40 and/or edit the notecard. For example, the notecard creator can authorize specific members to both view and review the notecard 40. Alternatively, the notecard creator can authorize some members to be able to view the notecard 40 but not provide reviews for it while other members are able to do both. The private level restricts any member other than the notecard creator from viewing and/or editing the notecard 40.

At step 214, the creator assigns the notecard to a category and one or more initial tags. Then, at step 216, information is entered into the notecard 40. In one implementation, the information is inserted into the public section 46 of the notecard 40. The information can include images associated with the notecard 40, tags associated with the notecard, and the like. The information can also be a review of the notecard 40 by a member. Shared and public notecards 40 may be reviewed by any member authorized to review them. The members may review the notecard 40 by performing any number of the following actions: selecting a rating for the notecard 40, entering comments into the public section 46, providing images, assigning tags, providing html links, selecting the notecard 40 as a member's favorite, and the like. Once added, the rating, comments, and the like may be displayed in the public section 46 of the notecard 40 for other members and the notecard creator. The overall rating of the notecard 40 may update each time a new rating is provided by a member. The ranking of the notecard 40 may also update with the change in the overall rating of the project 42 and/or addition of the notecard 40 as a member favorite.

### Method of Using the Workspace

FIG. 6 shows a method 300 for using the workspace 18. Method 300 begins at step 310 with a user logging into the workspace 18. Members may log into their account for the workspace 18 by providing an identification and password associated with the account. The identification may include a username, email address, or the like. The authentication engine 32 verifies the username and password and provides access to features of the workspace 18 reserved for authenticated members.

At step 312, a project 42 may be selected. Members can select the project 42 by searching for a project using the search engine 30, selecting a project from their favorite projects, or creating a new project 42 using the method 100 describe above.

At step 314, a notecard 40 is selected. Like projects, Members can select the notecard 40 by searching for a notecard using the search engine 30, selecting a notecard from their favorite notecards, or creating a new notecard 40 using the method 200 describe above.

At step 316, the selected notecard 40 is associated with a project 42. A single notecard 40 may be associated with more than one project 42. In one embodiment, the notecard 40 can be associated with the project 42 by any member authorized to edit the project 42. For example, if the project 42 has the public security level, any registered member may be allowed to associate a notecard 40 with the project 42. If the project 42 has the private security, only the project creator may be allowed to associate a notecard 40 with the project 42. Notecards 40 can be associated with projects 42 by viewing a list of notecards 40 in the workspace. A member can drag the icon 50 of the notecard 40 on the workspace to a listing of the project 42 in the member's navigation section 70. The member can drag the icon 50 over an item on the navigation section 70, such as, “my favorite projects 42.” If the listing of “my favorite projects” is not expanded, the listing will expand to show all projects 42 the user has selected as a favorite. Dragging and dropping the notecard 40 icon 50 over the desired project 42 will associate the notecard 40 with the project 42 and list the notecard 40 in the project 42. To aid in the selection of the notecards 40, hovering the cursor over the icon 50 of a notecard 40 or project 42 will pop up information contained in the notecard 40 or project 42.

At step 318, one or more notecards 40 are associated with the notecard 40 created in step 116. Associating notecards 40 with one another can organize information within the project 42. For example, category notecards 40 are especially configured for organizing multiple notecards 40 into a category. Notecards 40 can be associated with other notecards 40 by dragging the icon 50 of a notecard 40 and dropping over the icon 50 of another notecard. The notecards 40 are associated in a hierarchy. For example, if a first notecard 40 dragged and dropped over a second notecard 40 the second notecard 40 is a master and the first notecard 40 is a slave. If the second notecard is associated with the project, the first notecard will automatically be associated with the project 42 also. In contrast, if the first notecard is associated with a project, the second notecard is not automatically associated with the project 42.

At step 320, one or more projects 42 can be associated with the main project 42 created in step 1 10. Authorized members can associate the projects 42 with the main project 42 if the main project 42 is categorized as a challenge. If the main project 42 is categorized as a solution, only the projector creator may associate the projects with the main project. Associating projects 42 with the main project can allow members to submit a proposal (in the form of a project) to a challenge defined in the main project. Like notecards 40, projects 42 can be associated with other projects 42 by dragging and dropping project 42 icons 50 over other projects 42 or project icons. Moreover, associating a first project with a second project associates all notes and projects 42 that are slaves of the first project with the second project. This allows members to create a hierarchy of projects 42. It is possible to have a project 42 within a project 42 that is also within a third project 42 and so on. The projects 42 can be reused in many other projects as needed.

At step 322, the main project 42 can be reviewed. Shared and public projects 42 may be reviewed by any member authorized to review them. The members may review the project 42 by selecting a rating for the project, entering comments into the public section 46 of the project, selecting the project 42 as a member's favorite, and the like. Once added, the rating and/or comments are displayed in the public section 46 of the project 42 for other members and the project creator. The overall rating of the project 42 may update each time a new rating is provided by a member. The ranking of the project 42 may also update with the change in the overall rating of the project 42 and/or addition of the project 42 as a member favorite.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method for organizing and sharing information, comprising the steps of:
generating at least one notecard upon request, the notecard containing a restricted section and a public section, the restricted section accepting information from a creator of the notecard and restricting information sources other than the notecard creator, the public section accepting information from at least one source other than the notecard creator;
accepting information into the notecard;
generating at least one project; and
associating one or more notecards with one or more projects.

2. The method of claim 1, further comprising the step of providing a graphical user display of the notecard with the restricted and public sections of the notecard comprising different regions of the displayed notecard.

3. The method of claim 2, wherein the notecard includes one or more associated categories implemented as a part of the restricted section.

4. The method of claim 3, further comprising the step of displaying the categories along an edge of the displayed notecard.

5. The method of claim 3, wherein the public section further comprises a tag section listing keywords associated with the notecard, and wherein the method further comprises the step of permitting one or more sources other than the creator to add keywords to the tag section.

6. The method of claim 2, wherein the notecard includes an information section and wherein the providing step further comprises providing a display of the information section in a region of the notecard that is separate from the restricted and public sections.

7. The method of claim 6, further comprising automatically generating content for the information section and adding the content to the displayed information section.

8. The method of claim 7, wherein the generating step further comprising generating the content using a workspace engine that determines at least some of the content based on user interaction with the notecard.

9. The method of claim 2, further comprising the step of generating a graphical user display of one of the projects, the displayed project having a controlled section and a shared section.

10. The method of claim 9, wherein the displayed project has associated with it a number of notecards and wherein the method further comprises the step of displaying in the project an icon representing each of at least some of the associated notecards.

11. A system for organizing and sharing information in a workspace, comprising:
a web server;
a workspace engine operationally linked with the web server to manage the workspace; and
a client connected to the web server through a communication link for interacting with the workspace;
said workspace engine handling management of at least one notecard and at least one project for the workspace, said at least one notecard having:
a restricted section for accepting information from a creator of the notecard and restricting information from sources other than the notecard creator; and
a public section for accepting information from at least one source not accepted by the restricted section; and
said at least one project having one or more notecards associated with the project.

12. A system as defined in claim 11, wherein said web server and workspace engine are incorporated into a server.

13. A system as defined in claim 11, wherein said workspace engine comprises a portion of a collaboration engine.

14. A system as defined in claim 13, wherein said collaboration engine further comprises an authentication engine that provides secure access to portions of the workspace and that provides management of member accounts.

15. A system as defined in claim 11, wherein said workspace engine is operable to display said one or more notecards and projects on a client computer.

16. A system as defined in claim 11, wherein the notecard includes one or more associated categories implemented as a part of the restricted section.

17. A system as defined in claim 11, wherein the notecard includes categories located along an edge of the displayed notecard.

18. A system as defined in claim 11, wherein the public section further comprises a tag section listing keywords associated with the notecard.

19. A system as defined in claim 11, wherein the notecard includes an information section located in a region of the notecard that is separate from the restricted and public sections.

20. A system as defined in claim 11, wherein the workspace engine automatically generates content for the information section based at least in part on user interaction with the notecard.
